(19) United States
(12) Patent Application Publication
(10) Pub. No.: US 2009/0197993 A1
(43) Pub. Date: Aug. 6, 2009

(54) PREPARATIONS FOR USE IN CONCRETE

(76) Inventors: Rüdiger Musch, Bergisch Gladbach (DE); Horst Stepanski, Leverkusen (DE); Klaus Dilger, Braunschweig (DE); Stefan Böhm, Schwülper (DE); Frank Mund, Stadel (DE)

Correspondence Address: CONNOLLY BOVE LODGE & HUTZ, LLP, P O BOX 2207, WILMINGTON, DE, 19899, US

(21) Appl. No.: 12/296,172

(22) PCT Filed: Apr. 3, 2007
(86) PCT No.: PCT/EP07/02984

§ 371 Date: Jan. 9, 2009

(30) Foreign Application Priority Data
Apr. 6, 2006 (DE) 10 2006 016 608.6

(51) Int. Cl. C04B 16/06

(52) U.S. Cl. 524/8

(57) ABSTRACT

The invention provides the use of mixtures based on aqueous dispersions of polychloroprene to produce fiber products finished therewith, a process for the production thereof and the use of these finished fiber products to produce textile-reinforced and fiber-reinforced concrete and other products based on cement.

The invention provides the use of mixtures based on aqueous dispersions of polychloroprene to produce fiber products finished therewith, a process for the production thereof and the use of these finished fiber products to produce textile-reinforced and fiber-reinforced concrete and other products based on cement.

Concrete is one of the most important materials used in the construction industry and offers many advantages. It is inexpensive, durable and flexible with regard to design and production technique. The fields of application are correspondingly varied and cover both the static-structural and the non-load-bearing.

For the transfer of compression forces, concrete offers a particularly beneficial cost-to-performance ratio and is therefore used to a large extent in the construction industry.

Due to the low tensile strength of concrete, reinforcement is required in order to absorb tensile forces. Reinforcement usually consists of steel. In order to ensure bonding and to protect from corrosion, steel reinforcement of concrete is provided with a concrete covering that is at least 2-3 cm thick. This means that components are at least 4-6 cm thick, depending on the environmental stresses and the method of production. If corrosion-insensitive, non-metallic materials are used as reinforcement materials, then thinner concrete covering can be used and filigreed and thin-walled cross-sections can be produced as a result, as will be known.

According to the prior art, short fibers, for example, are added to strengthen thin-walled concrete parts. The position and orientation in the composite material of the short fibers that are currently mainly used cannot be clearly defined. The field of application of modern concretes strengthened with short fibers is therefore restricted substantially to components that are subject to low mechanical stress such as, for example, flooring screeds and objects such as plant pots, etc.

Long fibers, for example, in the form of rovings or textiles, exhibit greater effectiveness in thin-walled concrete components, and these may be arranged in the direction of the tensile stresses that occur.

In order to develop more demanding and also new types of, fields of application for fiber-concrete methods of construction, engineering textiles with reinforcement filaments in the direction of greatest tensile stress are provided. Engineering textiles (two-dimensional or multi-dimensional) such as non-wovens, nets, knitted fabrics or contoured knitted fabrics can currently be used only in individual cases for the industrial production of textile-reinforced concrete components. The reason for this is the current lack of production processes for working with such textiles to give components with complicated geometries. Present methods for the production of textile-reinforced components permit only linear flat shapes because in most cases dimensional stability of the textile is achieved by tension. Particularly in the case of complicated geometries, the application of tension during industrial production is impossible or possible to only a limited extent. At the moment it is not possible to insert flexible reinforcement textiles into such components in a reproducible manner.

Currently, steel, plastic or glass fibers are used according to the prior art to reinforce cement-bonded building materials. The plastic fibers are mostly polypropylene fibers, but also aramid fibers. Table 1 gives typical mechanical parameters of various fibers

TABLE 1
Properties of possible reinforcement fibers.

| | | Tensile | |
|---|---|---|---|
| Density | Strength | E-Modulus | |
| Material | [g/cm³] | [GPa] | [GPa] |
| Alkali-resistant AR-Glass | 2.5-2.7 | 1.7-2.0 | 74 |
| Carbon | 1.6-2.0 | 1.5-3.5 | 180-500 |
| Aramid | 1.44-1.45 | 2.8-2.9 | 59-127 |
| Polypropylene | 1.0 | 0.5-0.75 | 5-18 |

Among the large group of different glasses, so-called AR-glass fibers are the only ones suitable because only they have a sufficiently high resistance in the highly alkaline surroundings of cement-bonded building materials.

In the paper “USE OF ADHESIVES FOR TEXTILE-REINFORCED CONCRETE”, by S. Böhm, K. Dilger and F. Mund, presented at the 26^{th} Annual Meeting of the Adhesive Society in Myrtle Beach, S.C., USA, Feb. 26, 2003, it was shown that the theoretical value for yarn tensile strength/load-carrying capacity of reinforcement textiles in concrete is not achieved. The yarn tensile tests described in this publication showed that the yarn tensile strength can be increased by 30-40% by penetration with a polymeric phase. Such penetration was achieved by soaking rovings with various aqueous polymer dispersions, including those based on polychloroprene, and also with reactive resin formulations based on epoxide resin or unsaturated polyesters.

Three methods are known for polymeric coating and soaking of textile-reinforced concrete fibers:

Method 1: The first method is based on a 2-step system. The filaments or rovings are first coated or penetrated by a polymeric phase and then embedded in fine concrete. Polymers used for this process are aqueous dispersions based on polychloroprene, acrylate, chlorinated rubber, styrene-butadiene or reactive systems based on epoxide resin and those based on unsaturated polyesters.

Penetration of the rovings may take place by coating the filaments during roving production or by soaking the rovings before or after textile production. The polymeric phase is cured or crosslinked before introducing the strengthening textiles into the concrete. Afterwards, the rovings or textiles treated in this way are embedded in fine concrete. In order to be able to make use of the mechanical properties of the fibers, the resin must have expansion properties that are at least as good as those of the fibers.

Method 2: The second method comprises introducing thermoplastic filaments during roving production. These are then melted, they wet the filaments and, after solidification, lead to internal adhesive bonds. However in this case friction spun yarns are not used. Rather, thermoplastic filaments are added during production of the yarn.

Method 3: The third method is based on a 1-step system. In the 1-step system, the textiles are soaked, during the fresh concrete phase, with polymers added to the fine concrete.

Part of the present invention is aimed at improving the properties of the fiber products used for reinforcement and that are finished using method 1. Polychloroprene in the form of a strongly alkaline aqueous dispersion appears to be especially suitable here, due to its known properties, in particular when it is highly crystallizable.

It is known that such a polychloroprene is chemically very stable in alkaline surroundings. Therefore this polymer is highly qualified for use in concrete.

The material-mechanical properties of textile-strengthened concrete depend on the position of the textile reinforcement. It is known that, at room temperature, highly crystalline polychloroprene in the form of aqueous dispersions enables thorough soaking of the fibers. As a result of the crystallinity, the thoroughly soaked textile is so stiffened after drying that it can be introduced into the shuttered form-work rigid, as geometrically fixed reinforcement.

When warmed, the partly crystalline structure can be converted into an amorphous state so that the textile two-dimensional structure can be reshaped to give the three-dimensional shape desired and the textile then remains in this shape in a rigid form after cooling and recrystallization.

The mechanical stresses introduced to the concrete should preferably be distributed uniformly over the entire yarn cross-section of the textile, while avoiding localized stress peaks and should ensure the greatest possible bond between the concrete matrix and the textile when subjected to strain. This object is achieved by the mixture used according to the invention for thorough soaking of the textile. However, the adhesion of concrete to individual fibers should also be improved in order to improve the properties of concrete parts that contain admixed individual fibers for reinforcement purposes, e.g. flooring screeds.

Therefore, modification of the composition of a mixture based on polychloroprene dispersion was required, in such a way that the mechanical properties of concrete parts that are reinforced with fiber products which, for their part, were likewise treated with these mixtures, are substantially enhanced.

Fiber products in the context of the present invention are fibers, rovings, yarns, textiles, knitted fabrics, non-wovens or bonded fabrics.

The object of the present invention can be achieved by using an aqueous alkaline dispersion for soaking fiber products used to strengthen concrete that additionally contains, in addition to polychloroprene, inorganic solids, preferably from the group of oxides, carboxides and silicates, particularly preferably silicon dioxide, preferably in the form of nanoparticles. The effectiveness of the inorganic solids is increased even more if the polychloroprene contains a particularly high concentration of hydroxyl groups, typically a concentration of 0.1 to 1.5 mol % of chlorine atoms of the polychloroprene replaced by OH, and a high proportion of gel of up to 60% by weight of the dispersed polychloroprene, measured by determining the residue insoluble in THF.

The strength properties achieve maximum values when, after soaking, the fiber products are dried at elevated temperatures, generally above 20° C., preferably temperatures above 100° C., particularly preferably up to 220° C., above all when the inorganic solid used is zinc oxide.

The present invention therefore provides the use of an aqueous mixture containing
a) a polychloroprene dispersion with an average particle size of 60 to 220 nm, preferably 70 to 160 nm and
b) an aqueous dispersion of inorganic solids, preferably from the group of oxides, carboxides and silicates, particularly preferably silicon dioxide, preferably with an average particle diameter of 1 to 400 nm, preferably 5 to 100 nm, especially preferably 8 to 50 nm
   for soaking fiber products in order to strengthen concrete.

The polychloroprene dispersion (a) is in principle obtainable using known methods, preferably by:
polymerization of chloroprene in the presence of 0-1 mmol, with respect to 100 g of monomer, of a regulator, at temperatures of 0° C.-70° C., wherein the dispersion contains a proportion of 0-30 wt. %, with respect to the polymer, that is insoluble in organic solvents,
removal of the residual non-polymerized monomers by steam distillation,
storage of the dispersion at temperatures of 50° C.-110° C., wherein the proportion that is insoluble (i.e. the gel fraction) in organic solvents (THF) rises to 0.1 wt. % to 60 wt. %, and increasing the proportion of solids to 50-64 wt. % by a creaming process.

In a preferred embodiment of the invention, following soaking according to the invention of fiber products with the mixture, the mixture is crosslinked on the substrate after removing the water at temperatures of 20° C.-220° C.

The preparation of polychloroprene has been known for a long time. It is accomplished by emulsion polymerization in alkaline aqueous medium; see “Ullmanns Encyolopadie der technischen Chemie”, vol. 9, p. 366, Verlag Urban und Schwarzenberg, Munich-Berlin 1957; “Encyclopedia of Polymer Science and Technology”, vol. 3′ p. 705730, John Wiley, New York 1965; “Methoden der Organischen Chemie” (Houben-Weyl) XIV/1, 738 et seq., Georg Thieme Verlag Stuttgart 1961.

Suitable emulsifiers are in principle all compounds and mixtures thereof that stabilize the emulsion sufficiently, such as e.g. water-soluble salts, in particular sodium, potassium and ammonium salts of long-chain fatty acids, rosin and rosin derivatives, higher molecular weight alcohol sulfates, arylsulfonic acids, formaldehyde condensates of arylsulfonic acids, non-ionic emulsifiers based on polyethylene oxide and polypropylene oxide as well as emulsifying polymers such as polyvinyl alcohol (DE-A 2 307 811, DE-A 2 426 012, DE-A 2 514 666, DE-A 2 527 320, DE-A 2 755 074, DE-A 3 246 748, DE-A 1 271 405, DE-A 1 1301 502, U.S. Pat. No. 2,234,215, JP-A 60-31 510).

According to the invention, suitable polychloroprene dispersions are prepared by emulsion polymerization of chloroprene and an ethylenically unsaturated monomer that is copolymerizable with chloroprene, in alkaline medium. Particularly preferred polychloroprene dispersions are prepared by continuous polymerization such as are described, e.g., in WO-A 2002/24825 (Example 2), and DE 3 002 734 (Example 6), and the regulator content may be varied between 0.01% and 0.3%.

The chain transfer agents required to adjust the viscosity are, e.g., mercaptans.

Particularly preferred chain transfer agents are n-dodecyl mercaptan and the xanthic disulfides used in accordance with DE-A 3 044 811, DE-A 2 306 610 and DE-A 2 156 453.

After polymerization, residual chloroprene monomer is removed by steam distillation. This is performed as described, for example, in “W. Obrecht in Houben-Weyl. Methoden der organischen Chemie,” vol. 20, part 3, Makromolekulare Stoffe (1987), p. 852.

In a preferred embodiment of the present invention, the low-monomer polychloroprene dispersion prepared in this way is then stored at elevated temperatures. In this way, some of the labile chlorine atoms are eliminated (about 0.1 to 1.5 mol. % of the chlorine atoms of the polychloroprene) and a polychloroprene network that is not soluble in organic solvents (gel) is built up.

In another step, the solids content of the dispersion is preferably increased by means of a creaming process. This creaming process is performed, for example, by adding alginates as described in “Neoprene Latices,” John C. Carl, E. I. Du Pont 1964, p. 13 or EP-A 1 293 516.

Aqueous dispersions of inorganic solids, preferably from the group of oxides, carboxides and silicates, particularly preferably silicon dioxide, are known. They are available in a variety of structures, depending on the manufacturing process.

Silicon dioxide dispersions that are suitable according to the invention can be obtained on the basis of silica sol, silica gel, fumed silicas or precipitated silicas or mixtures of these.

Aqueous dispersions of inorganic solids that are preferably used according to the invention are those in which the particles have a primary particle size of 1 to 400 nm, preferably 5 to 100 m and particularly preferably 8 to 50 nm. Preferred mixtures according to the invention are those in which the particles of inorganic solids, e.g. the SiO₂ particles in a silicon dioxide dispersion b), are present as discrete non-aggregated primary particles. It is also preferred that the particles have hydroxyl groups available at the surface of the particles. Aqueous silica sols are particularly preferably used as aqueous dispersions of inorganic solids. Silicon dioxide dispersions that can be used according to the invention are disclosed in WO 2003/102066.

An essential property of the dispersions of inorganic solids used according to the invention is that, in the formulations themselves, they do not act as thickeners, or only do so to a negligible extent, upon adding water-soluble salts (electrolytes) or substances that can go partially into solution and increase the electrolyte content of the dispersion, such as e.g. zinc oxide. Their thickening effect in formulations of polychloroprene dispersions should not exceed 2000 mPa s, preferably 1000 mPa s. This applies, in particular, to silicas.

To prepare the mixture according to the invention, the quantitative proportions of the individual components are selected such that the resulting dispersion has a concentration of non-volatile components of 30 to 60 wt. %, wherein the proportion of polychloroprene dispersion (a) amounts to 20 to 99 wt. % and the dispersion of inorganic solids (b) amounts to 1 to 80 wt. %, wherein the percentage data refer to the weight of non-volatile components and add up to 100 wt. %.

Mixtures according to the invention preferably contain a proportion of 70 wt. % to 98 wt. % of a polychloroprene dispersion (a) and a proportion of 2 wt. % to 30 wt. % of a dispersion of inorganic solids (b), wherein the percentage data refer to the weight of non-volatile components and add up to 100 wt. %.

Polychloroprene dispersions (a) as defined herein to represent the total polymer content may optionally also contain other dispersions, such as e.g. polyacrylate, polyvinylidenechloride, polybutadiene, polyvinylacetate or styrene-butadiene dispersions or mixtures thereof, in a proportion of up to 30 wt. %, with respect to the entire dispersion (a).

Dispersions (a) and/or (b) or the entire mixture according to the invention may optionally contain further auxiliary substances and additives that are known from adhesive and dispersion technology, e.g., resins, stabilizers, antioxidants, crosslinking agents and crosslinking accelerators. For example, fillers such as quartz flour, quartz sand, barytes, calcium carbonate, chalk, dolomite or talcum, optionally together with wetting agents, for example polyphosphates, such as sodium hexametaphosphate, naphthalenesulfonic acid, ammonium or sodium polyacrylates may be added, wherein the fillers are added in amounts of 10 to 60 wt. %, preferably 20 to 50 wt. %, and the wetting agents are added in amounts of 0.2 to 0.6 wt. %, all weight percentages being with respect to the non-volatile components.

Other suitable auxiliary agents such as, for example, organic thickeners such as cellulose derivatives, alginates, starches, starch derivatives, polyurethane thickeners or polyacrylic acid may be added to the dispersions (a) and/or (b) or the entire mixture, in amounts of 0.01 to 1 wt. %, with respect to non-volatile components. Inorganic thickeners such as, for example, bentonites, may alternatively be added in amounts of 0.05 to 5 wt. %, with respect to the non-volatile components. The thickening effect in the formulation should not exceed 2000 mPa s, preferably 1000 mPa s.

For preservation purposes, fungicides may also be added to compositions according to the invention. Those are used in amounts of 0.02 to 1 wt. %, with respect to non-volatile components. Suitable fungicides are, for example, phenol and cresol derivatives or organotin compounds or azole derivatives such as tebuconazole^{INN} or ketoconazole^{INN}.

Optionally, tackifying resins such as unmodified or modified natural resins such as rosin esters, hydrocarbon resins or synthetic resins such as phthalate resins may also be added to compositions according to the invention, or to the components used to prepare them, in dispersed form (see e.g. “Klebharze” R. Jordan, R. Hinterwaldner, p. 75-115, Hinterwaldner Verlag Munich 1994). Alklyphenol resin and terpenephenol resin dispersions with softening points higher than 70° C., particularly preferably higher than 110° C., are preferred.

It is also possible to use organic solvents such as, for example, toluene, xylene, butyl acetate, methyl ethyl ketone, ethyl acetate, dioxane or mixtures of these or plasticizers such as, for example, those based on adipate, phthalate or phosphate, in amounts of 0.5 to 10% by weight with respect to non-volatile components.

Mixtures to be used according to the invention are prepared by mixing the polychloroprene dispersion (a) with the dispersion of inorganic solids (b) and optionally adding conventional auxiliary substances and additives to the mixture obtained or to both components or to individual components.

A preferred process for producing the mixtures to be used according to the invention is characterized in that the polychloroprene dispersion (a) is first blended with the auxiliary substances and additives and a dispersion of inorganic solids (b) is added during or after the blending thereof.

Mixtures to be used according to the invention can be applied in known ways, e.g., by painting, casting, spraying or immersing. The film produced can be dried at room temperature or at an elevated temperature up to 220° C.

Mixtures to be used according to the invention may also be used as adhesives, for example, to bond any substrates of identical or different type. The adhesive layer on or in the type of substrate obtained may then be crosslinked. The substrates obtained in this way may optionally be used to strengthen (reinforce) concrete.

Fiber products treated in accordance with the invention are generally advantageous for strengthening or reinforcing concrete. However, they are especially advantageously used to produce those cement-bonded products that are distinguished in that they have to withstand a sudden point load.

Therefore fiber products treated in accordance with the invention are particularly highly suitable for the production of, for example, ballistic-resistant facade elements, bunker walls and bunker doors, strong-room walls, armour-plating and armour-plated parts for military vehicles, such as are used for example in gun-turrets, coverings and barriers against rock falls and avalanches, crash-barriers, anti-impact elements, bridges and bridge elements, earthquake-safe buildings or parts of buildings, doors and door elements, in particular safety doors, doors for shelters and bunkers, pylons, in particular overhead cable pylons for the power industry, roofs and roof parts.

These uses and the items obtained for these uses are therefore also a part of the present invention.

### EXAMPLES

### A) Preparing the Polychloroprene Dispersions

Chloroprene or the polychloroprene dispersion is polymerized in a continuous process as described in EP-A 0 032 977.

### Example 1

Into the first reactor of a polymerization cascade consisting of 7 identical reactors, each with a volume of 50 liters, are introduced the aqueous phase (W) and the monomer phase (M) in a permanently constant ratio, via a measurement and control apparatus, and also the activator phase (A). The mean residence time in each tank is 25 minutes. The reactors are the same as those described in DE-A 2 650 714 (data in parts by wt. per 100 g parts by wt. of monomers used).

(M)=monomer phase:

| | | |
|---|---|---|
| chloroprene | 100.0 | parts by weight |
| n-dodecyl mercaptan | 0.11 | part by weight |
| phenothiazine | 0.005 | part by weight |

(W)=aqueous phase:

| | |
|---|---|
| dematerialized water | 115.0 parts by weight |
| sodium salt of disproportionated abietic acid | 2.6 parts by weight |
| potassium hydroxide | 1.0 parts by weight |

(A)=activator phase:

| | |
|---|---|
| 1% aqueous formamidine sulfinic acid solution | 0.05 part by weight |
| potassium persulfate | 0.05 part by weight |
| anthraquinone-2-sulfonic acid sodium salt | 0.005 part by weight |

The reaction starts up readily at an internal temperature of 15° C. The heat of polymerization being released is removed and the polymerization temperature is held at 10° C. by an external cooling system. At a monomer conversion of 70%, the reaction is terminated by adding diethylhydroxylamine. The residual monomer is removed from the polymers by steam distillation. The solids content is 33 wt. %, the gel content is 0 wt. % and the pH is 13.

After a polymerization time of 120 hours, the mixture leaves the polymerization line.

Then the dispersion thus prepared is creamed according to the following process.

Solid alginate (Manutex) is dissolved in deionised water and a 2 wt. % alginate solution is prepared. 200 g of the polychloroprene dispersion are initially introduced to each of eight 250 ml glass bottles and 6 to 20 g of the alginate solution is stirred, in 2 g steps, into each bottle. After a storage time of 24 hours, the amount of serum being formed above the thick latex is measured. The amount of alginate in the sample with the greatest serum formation is multiplied by 5 and gives the optimum amount of alginate to cream 1 kg of polychloroprene dispersion.

### Example 2

The same procedure as described in Example 1 is followed, but the amount of regulator in the monomer phase is reduced to 0.03 wt. %.

The solids content is 33 wt. % and the gel content is 1.2 wt. %; the pH is 12.9

After steam distillation, the dispersion is conditioned in an insulated storage tank for 3 days at a temperature of 80° C., wherein the temperature is post-regulated, if required, by a supplementary heating system and the rise in gel content in the latex is measured taking samples.

This dispersion is also creamed in the process described in Example 1.

### B) Substances Used

| | | | |
|---|---|---|---|
| Polychloroprene | average particle size | | Gel: 0%, |
| dispersion from | 90 nm*⁾ | | Solids: 58%, |
| Example 1 | | | pH: 12.9 |
| Polychloroprene | average particle size | | Gel: 16%, |
| dispersion from | 110 nm*⁾ | | Solids: 56%, |
| Example 2 | | | pH: 12.7 |
| Silicon dioxide | Dispercoll ® S 5005 | Bayer MaterialScience | Solids: 50%, |
| dispersion | average primary | AG | surface area: 50 m²/g |
| | particle size | | |
| | 50 nm | | |
| Acrylate | Plextol ® E 220 | Polymer Latex GmbH | Solids: 60%, |
| dispersion | average particle size | & Co. KG | pH: 2.2 |
| | 630 nm*⁾ | | |
| Antioxidant | Rhenofit ® DDA 50 EM | Rhein Chemie GmbH | 50% solids in water |
| Zinc oxide | VP 9802 | Borchers GmbH | 50% solids in water |
| Terpene-phenol | HRJ 11112 | Schenectady | 50% solids in water |
| resin dispersion | | International, Inc. | |

*⁾determined by the ultra-centrifuge sedimentation method

### C) Examples

The following formulations were made up (data in parts by weight):

| | Formulation No. | | | | |
|---|---|---|---|---|---|
| | 1 | 2 | 3 | 4 | 5 |
| Polychloroprene dispersion 1 | 100 | 100 | 100 | — | — |
| Polychloroprene dispersion 2 | — | — | — | 100 | 100 |
| Dispercoll ® S 5005 | — | — | 30 | 30 | 30 |
| Plextol ® E 220 | 30 | — | — | — | — |
| HRJ 11112 resin | — | 30 | — | — | — |
| Rhenofit ® DDA 50 EM | 2 | 2 | 2 | 2 | 2 |
| ZnO Borchers | 4 | 4 | — | — | 4 |

### Examples 1 and 2

### Comparison

### Examples 3 to 5

### According to the Invention

Alkali resistant Vetrotex® glass fiber rovings with a thickness of 2400 tex were soaked with these formulations and then dried in the open in the laboratory, suspended and loaded with weights.

The forces required to “pull-out” specimens prepared in this way from a concrete block were tested. The following procedure was used:

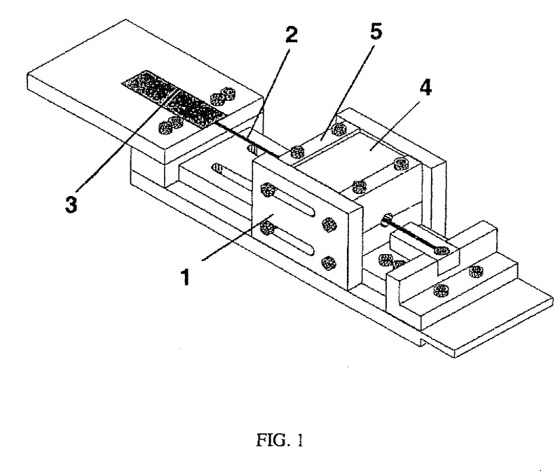

To prepare the specimens for the pull-out test, the mould and formwork 1 shown in FIG. 1 is used: the fiber 2 is clamped in the formwork 3. The space for filling with concrete 4 is designed so that the thickness of the pull-out body can be varied by moving a wall 5. All gaps and the feedthrough for the roving from the formwork are sealed with sealants.

The concrete formulation was prepared as follows:

| Feedstock | Type | Source | Parts by wt. |
|---|---|---|---|
| Binder | | | |
| Cement | CEM I 52.5 | Spenner Zement, Erwitte | 490 |
| Additives | | | |
| Fly ash | Safament HKV | Jacob GmbH, Völklingen | 175 |
| Silica dust | EMSAC 500 | Woermann, Darmstadt | 70 |
| slurry | DOZ | | |
| Plasticizer | FM 40 | Sika Addiment, Leimen | 10.5 |
| Aggregates | | | |
| Quartz flour | Milisil W3 | Quarzwerke Frechen | 499 |
| Sand | 0.2-0.6 mm | Quarzwerke Frechen | 714 |
| Other | | | |
| Water | Tap water | STAWAG, Aachen | 245 |

| | |
|---|---|
| Mixing instructions: | Weigh out all substances accurately |
| | to 0.1 g. |
| | 1. Homogenize cement, fly ash and |
| | aggregates (part mix 1) |
| | 2. Water, silica slurry and 50% of |
| | plasticizer in this sequence in mortar |
| | mixer (DIN 196-1) (part mix 2) |
| | 3. Carefully add part mix 1 to part mix |
| | 2; mix for 1.5 min at low speed setting |
| | 4. Wait for 2 min |
| | 5. Add remaining plasticizer and mix for |
| | a further 1.5 min at low speed setting |
| | — |

Note
Strip formwork after 1 day

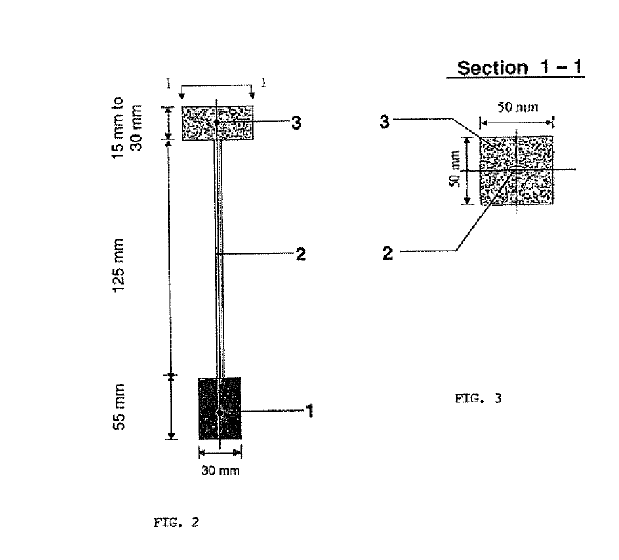

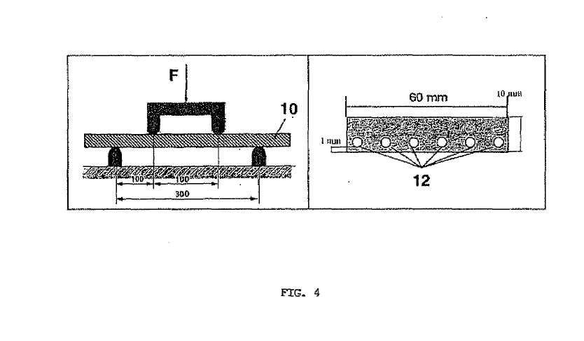

The layout and dimensions of a pull-out specimen and the test set-up are shown in FIGS. 2 and 3.

Sample holder 1 was suspended on a universal joint in order to keep the effects of torque and lateral forces small. A rubber coating smoothed out small irregularities on the surface of the concrete block and thus ensured more uniform distribution of pressure.

The test speed during the tests was 5 mm/min. The rovings 2 were embedded 20 mm inside the concrete.

During the pull-out test, the critical force is that at which the roving 2 becomes loosened from the concrete matrix 3 and starts to slip out.

Force at which the Roving Begins to Slip Out of the Concrete:

| | Formulation No. | | | | |
|---|---|---|---|---|---|
| | | | 3 | 4 | 5 |
| | 1 | 2 | (acc. | (acc. | (acc. |
| | (Comp) | (Comp) | to inv.) | to inv.) | to inv.) |
| Mean value [N] | 75 | 99 | 148 | 177 | 167 |
| Standard deviation [N] | — | 14 | 19 | 29 | 24 |
| Number of samples | 1 | 3 | 5 | 5 | 4 |

To investigate the component properties of textile-reinforced concrete elements, strip-shaped specimens were also prepared. The concrete used was a ready-mixed supply from Durapact GmbH (Haan) with the name “Durapact Matrix”. The reinforcement used comprised 6 alkali-resistant (AR) glass fiber rovings with a thickness of 2400 tex from Vetrotex®, laid in the tensile plane of the specimen with a concrete covering of one mm. The specimens were stored at room temperature and a humidity of about 95% for 28 days after preparation. Before the tests, they were then dried for 2 days at room temperature. The test performed was the 4-point flexural tension test, similar to EN 1170-5, with the following boundary conditions:
Dimensions of the specimens: 325 mm×60 mm×10 mm
Reinforcement: 6 Vetrotex® AR glass rovings 2400 tex positioned in the tensile plane with a one millimeter concrete covering
Test speed: 1 mm/min
Environmental conditions: Laboratory surroundings, room temperature

The test set-up and the specimen are shown in FIG. 4 (Experimental setup for 4-point flexural tension test and specimen)

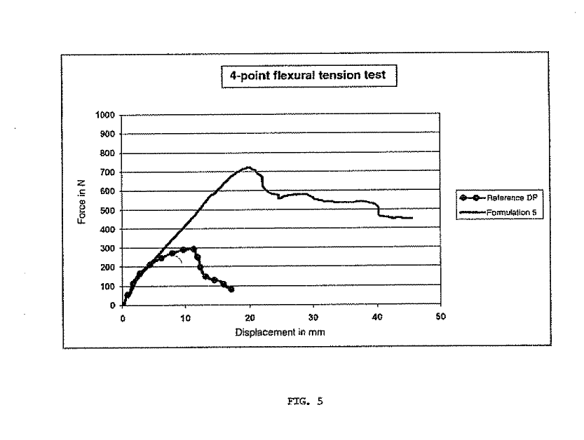

The reinforcing fibers were introduced into the specimens uncoated in one set of tests and, in a second set of tests, coated with polychloroprene formulation no. 5 as described above (Table C). Five specimens were tested in each set of experiments. FIG. 5 (results of flexural tension tests of specimens with reinforcement coated with polychloroprene and uncoated (reference DP)) shows characteristic traces of curves for one sample from each set. In the diagram, the flexural tensile force is plotted via the transverse displacement.

The upper curve refers to a specimen with polychloroprene coated reinforcement, the lower to an uncoated reference sample. A clear improvement in mechanical properties of the component due to coating can be seen, as given in the list below:
Increase in maximum flexural tension force;
Increase in deflection at maximum flexural tension force;
Increase in maximum deflection;
Magnification of the amount of energy uptake or work done during the test, this being characterized by the size of the area under the curve.

This type of tough fracture behavior is a recognized feature demonstrating the suitability of a material for constructions that are subjected to high dynamic stresses. In the construction industry, this relates in particular to high dynamic stresses arising as a result of e.g. earthquakes, vehicle impacts, bombardment or explosion pressure waves.

1. Use of fiber products soaked or coated with mixtures of
a) 20-99% by weight of an aqueous dispersion based on polychloroprene,
b) 1-80% by weight of an aqueous suspension based on inorganic solids, preferably from the group of oxides, carboxides and silicates,
c) optionally in addition other polymer dispersions, in particular from the group of polyacrylates, polyacetates, polyurethanes, polyureas, rubbers and epoxides, and also
d) optionally additionally containing additives customary with polymer dispersions, for producing cement-bound products equipped with a textile reinforcement and capable of withstanding sudden point loads.

2. Use according to claim 1, characterized in that the solid in the suspension (b) consists of silicon dioxide, preferably containing silanol groups, to an extent of more than 20% by weight.

3. Use according to claim 2, characterized in that the primary particle size of the silicon dioxide is between 1 to 400 nm, preferably 5 to 100 nm and especially preferably 8 to 50 nm.

4. Use according to claim 1, characterized in that the polychloroprene contains chemically attached hydroxide groups in 0.1 to 1.5% of the polymerized monomeric groups.

5. Use according to claim 1, characterized in that the mixture contains up to 10% by weight of zinc oxide.

6. Use according to claim 1, characterized in that the products capable of withstanding sudden point loads comprise ballistic-resistant facade elements.

7. Use according to claim 1, characterized in that the products capable of withstanding sudden point loads comprise coverings and barriers against rock falls and avalanches.

8. Use according to claim 1, characterized in that the products capable of withstanding sudden point loads comprise crash-barriers.

9. Use according to claim 1, characterized in that the products capable of withstanding sudden point loads comprise anti-impact elements.

10. Use according to claim 1, characterized in that the products capable of withstanding sudden point loads comprise bridges and bridge elements.

11. Use according to claim 1, characterized in that the products capable of withstanding sudden point loads comprise earthquake-safe buildings or parts of buildings.

12. Use according to claim 1, characterized in that the products capable of withstanding sudden point loads comprise doors, in particular safety doors.

13. Use according to claim 1, characterized in that the products capable of withstanding sudden point loads comprise pylons.

14. Use according to claim 1, characterized in that the products capable of withstanding sudden point loads comprise roofs or roof parts.

15. Use according to claim 1, characterized in that the products capable of withstanding sudden point loads comprise strong rooms.

16. Use according to claim 1, characterized in that the products capable of withstanding sudden point loads comprise armour-plating elements for military vehicles.

17. Objects capable of withstanding sudden point loads and obtainable from cement-bound materials of construction reinforced with fiber products, the fiber products being soaked or coated with mixtures of
a) 20-99% by weight of an aqueous dispersion based on polychloroprene,
b) 1-80% by weight of an aqueous suspension based on inorganic solids, preferably from the group of oxides, carboxides and silicates,
c) optionally in addition other polymer dispersions, in particular from the group of polyacrylates, polyacetates, polyurethanes, polyureas, rubbers and epoxides, and also
d) optionally additionally containing additives customary with polymer dispersions, selected from the group consisting of ballistic-resistant facade elements, strong-room walls, bunker walls, armour-plating and armour-plating elements for military vehicles, gun-turrets, coverings and barriers against rock falls and avalanches, crash-barriers, anti-impact elements, bridges and bridge elements, earthquake-safe buildings or parts of buildings, doors and door elements, safety doors, doors for shelters and bunkers, pylons, roofs and roof parts.
